(19) United States
(12) Patent Application Publication
(10) Pub. No.: US 2022/0224395 A1
(43) Pub. Date: Jul. 14, 2022

(54) BEAM INDICATIONS OF VARIOUS BEAM INDICATION TYPES

(71) Applicant: QUALCOMM Incorporated, San Diego, CA (US)

(72) Inventors: Yan ZHOU, San Diego, CA (US); Tianyang BAI, Somerville, NJ (US); Tao LUO, San Diego, CA (US)

(21) Appl. No.: 17/647,258

(22) Filed: Jan. 6, 2022

Related U.S. Application Data
(60) Provisional application No. 63/136,022, filed on Jan. 11, 2021.

(51) Int. Cl. H04B 7/06

(52) U.S. Cl. CPC H04B 7/0695

(57) ABSTRACT

Various aspects of the present disclosure generally relate to wireless communication. In some aspects, a base station may transmit a set of beam indications, associated with a set of beam indication types, for a set of beams to use for communication via a set of channels. The set of beam indications includes a first beam indication, associated with a first beam indication type, that indicates to use a first beam for communication via at least a first channel of the set of channels. The base station may select, based at least in part on the set of beam indication types, a second beam indication type for transmission of a second beam indication that indicates to use a second beam for communication via the first channel of the set of channels. The base station may transmit the second beam indication using the second beam indication type. Numerous other aspects are described.

### CROSS-REFERENCE TO RELATED APPLICATION

This Patent application claims priority to U.S. Provisional Patent Application No. 63/136,022, filed on Jan. 11, 2021, entitled “BEAM INDICATIONS OF VARIOUS BEAM INDICATION TYPES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for beam indications of various beam indication types.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a base station includes transmitting, to a user equipment (UE), a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels; selecting, based at least in part on the set of one or more beam indication types, a second beam indication type for transmission of a second beam indication that indicates to use a second beam for communication via at least the first channel of the set of channels; and transmitting the second beam indication using the second beam indication type.

In some aspects, a method of wireless communication performed by a UE includes receiving a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels; receiving, after reception of the set of one or more beam indications, a second beam indication, associated with a second beam indication type, that indicates to use a second beam for communication via at least the first channel; and communicating via the set of channels based at least in part on application of the second beam indication to one or more channels of the set of channels.

In some aspects, a base station for wireless communication includes a memory and one or more processors coupled to the memory, the memory and the one or more processors configured to: transmit, to a UE, a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels; select, based at least in part on the set of one or more beam indication types, a second beam indication type for transmission of a second beam indication that indicates to use a second beam for communication via at least the first channel of the set of channels; and transmit the second beam indication using the second beam indication type.

In some aspects, a UE for wireless communication includes a memory and one or more processors coupled to the memory, the memory and the one or more processors configured to: receive a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels; receive, after reception of the set of one or more beam indications, a second beam indication, associated with a second beam indication type, that indicates to use a second beam for communication via at least the first channel; and communicate via the set of channels based at least in part on application of the second beam indication to one or more channels of the set of channels.

In some aspects, a non-transitory computer-readable medium storing a set of instructions for wireless communication includes one or more instructions that, when executed by one or more processors of a base station, cause the base station to: transmit, to a UE, a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels; select, based at least in part on the set of one or more beam indication types, a second beam indication type for transmission of a second beam indication that indicates to use a second beam for communication via at least the first channel of the set of channels; and transmit the second beam indication using the second beam indication type.

In some aspects, a non-transitory computer-readable medium storing a set of instructions for wireless communication includes one or more instructions that, when executed by one or more processors of a UE, cause the UE to: receive a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels; receive, after reception of the set of one or more beam indications, a second beam indication, associated with a second beam indication type, that indicates to use a second beam for communication via at least the first channel; and communicate via the set of channels based at least in part on application of the second beam indication to one or more channels of the set of channels.

In some aspects, an apparatus for wireless communication includes means for transmitting, to a UE, a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels; means for selecting, based at least in part on the set of one or more beam indication types, a second beam indication type for transmission of a second beam indication that indicates to use a second beam for communication via at least the first channel of the set of channels; and means for transmitting the second beam indication using the second beam indication type.

In some aspects, an apparatus for wireless communication includes means for receiving a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels; means for receiving, after reception of the set of one or more beam indications, a second beam indication, associated with a second beam indication type, that indicates to use a second beam for communication via at least the first channel; and means for communicating via the set of channels based at least in part on application of the second beam indication to one or more channels of the set of channels.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency chains, power amplifiers, modulators, buffers, processors, interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example associated with beam indications associated with various beam indication types, in accordance with the present disclosure.

FIGS. 4 and 5 are diagrams illustrating example processes associated with beam indications associated with various beam indication types, in accordance with the present disclosure.

FIGS. 6 and 7 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

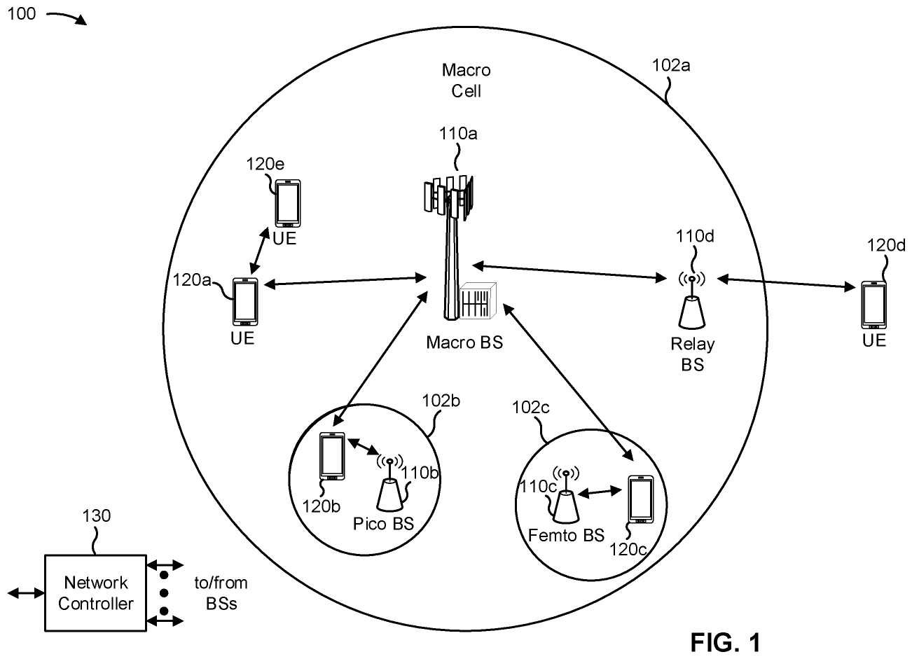

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

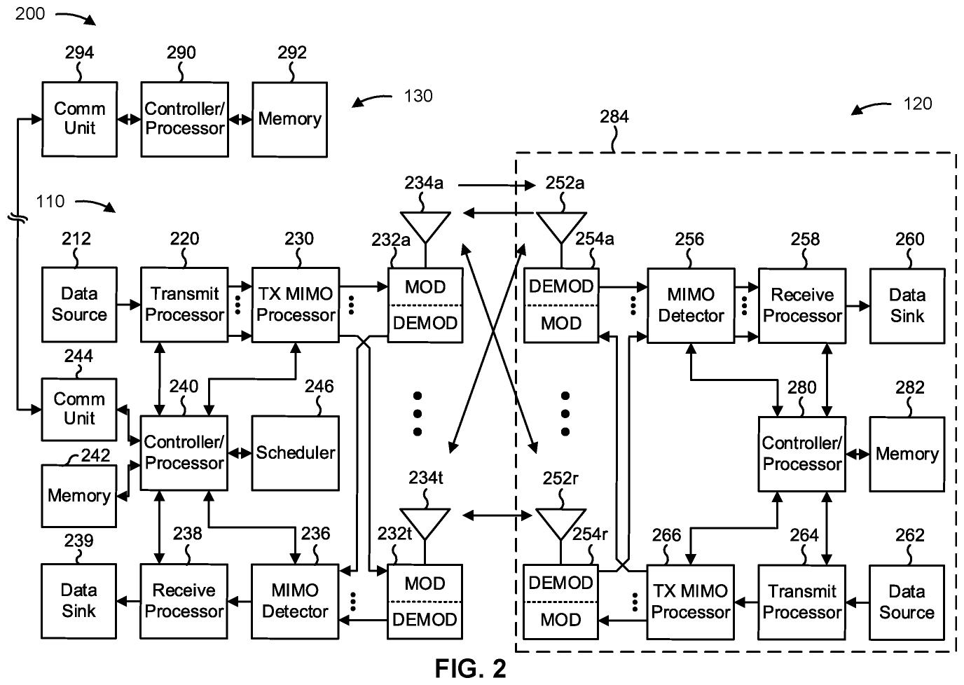

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

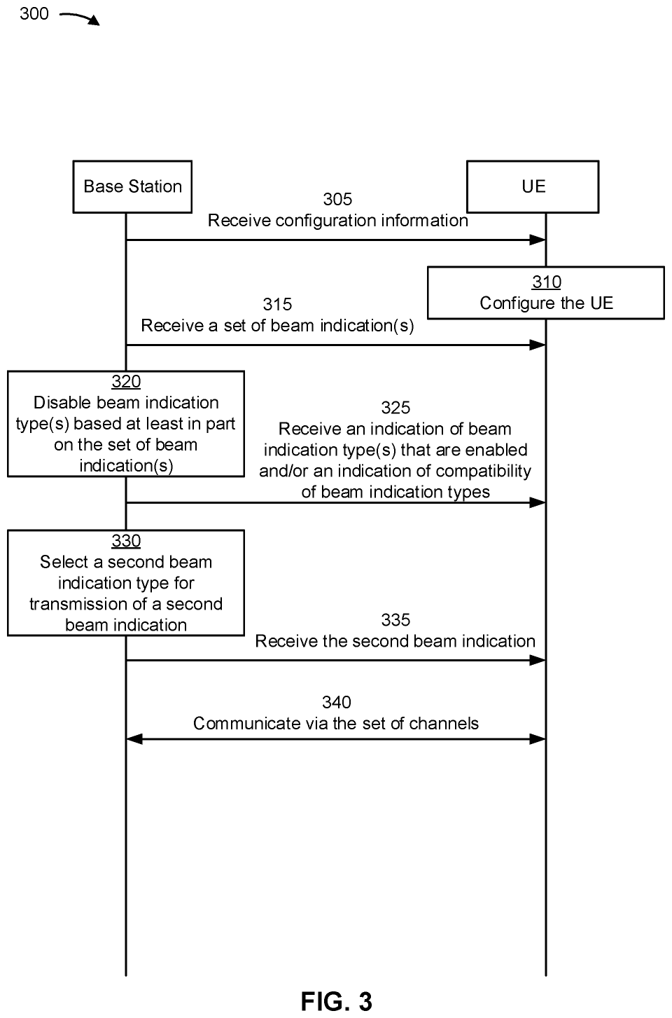

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 3-7).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 3-7).

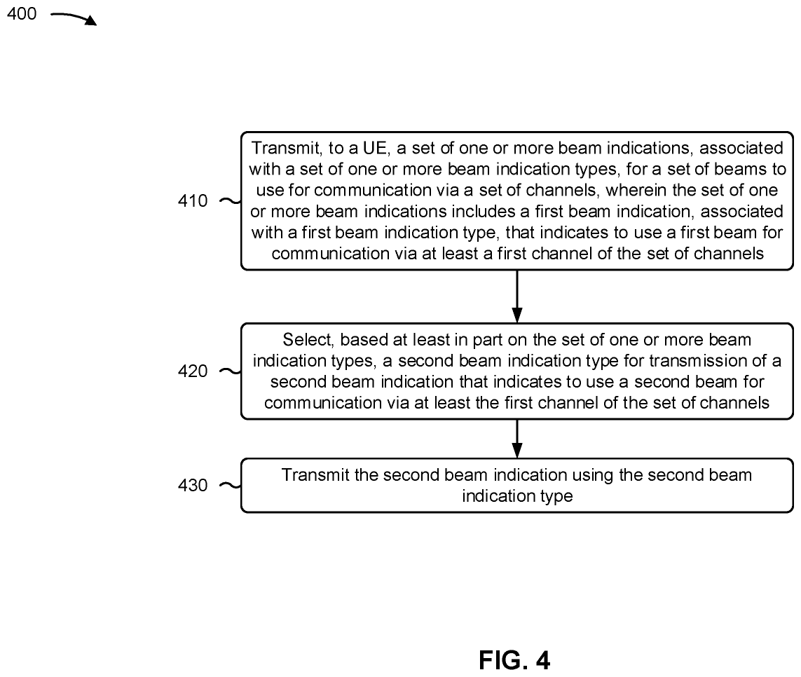

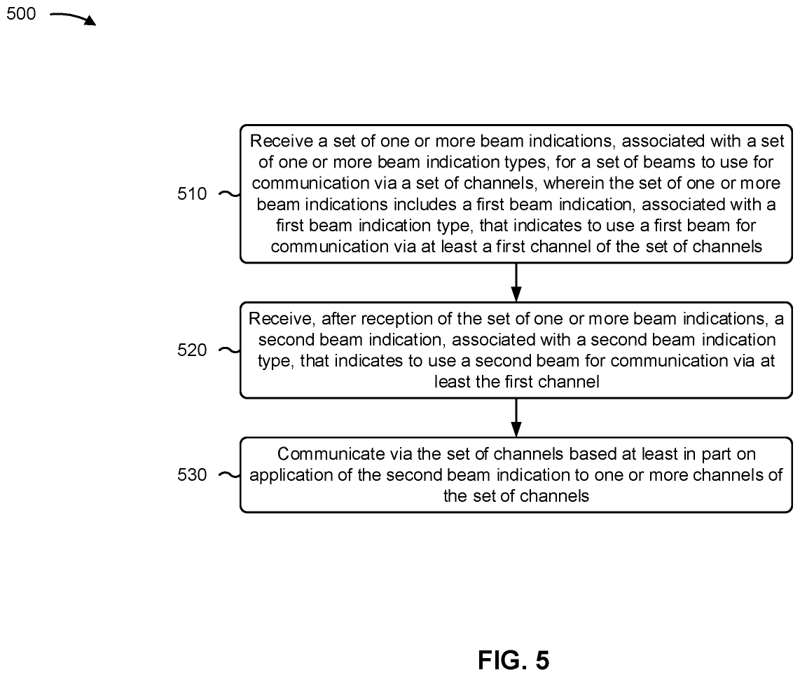

Controller/processor 240 of base station 110, controller/processor 280 of UE 120, and/or any other component(s) of FIG. 2 may perform one or more techniques associated with beam indications associated with various beam indication types, as described in more detail elsewhere herein. For example, controller/processor 240 of base station 110, controller/processor 280 of UE 120, and/or any other component(s) of FIG. 2 may perform or direct operations of, for example, process 400 of FIG. 4, process 500 of FIG. 5, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 400 of FIG. 4, process 500 of FIG. 5, and/or other processes as described herein. In some aspects, executing instructions may include running the instructions, converting the instructions, compiling the instructions, and/or interpreting the instructions, among other examples.

In some aspects, the base station includes means for transmitting, to a UE, a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels; means for selecting, based at least in part on the set of one or more beam indication types, a second beam indication type for transmission of a second beam indication that indicates to use a second beam for communication via at least the first channel of the set of channels; and/or means for transmitting the second beam indication using the second beam indication type. The means for the base station to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

In some aspects, the base station includes means for selecting the second beam indication type based at least in part on the second beam indication type being a same beam indication type as the first beam indication type.

In some aspects, the base station includes means for disabling one or more beam indication types for the set of channels based at least in part on transmission of the set of one or more beam indications, wherein selecting the second beam indication type comprises selecting the second beam indication type from a set of beam indication types that are not disabled.

In some aspects, the base station includes means for selecting the second beam indication type based at least in part on the second beam indication type being associated with a higher priority than a priority associated with the first beam indication type.

In some aspects, the base station includes means for transmitting an indication of one or more beam indication types that are enabled for subsequent beam indications, wherein transmitting the indication of the one or more beam indication types that are enabled for subsequent beam indications comprises transmitting the indication via one or more of: radio resource control signaling, medium access control signaling, or downlink control information signaling.

In some aspects, the base station includes means for transmitting an indication of one or more beam indication types that are enabled for subsequent beam indications, wherein transmitting the indication of the one or more beam indication types that are enabled for subsequent beam indications comprises transmitting an implied indication via one or more of: configuration information associated with the one or more beam indication types, beam indication type indicators associated with candidate beam indications, or operation parameters, associated with an uplink transmission or a downlink transmission, signaled with the set of one or more beam indications.

In some aspects, the UE includes means for receiving a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels; means for receiving, after reception of the set of one or more beam indications, a second beam indication, associated with a second beam indication type, that indicates to use a second beam for communication via at least the first channel; and/or means for communicating via the set of channels based at least in part on application of the second beam indication to one or more channels of the set of channels. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE includes means for applying the second beam indication to the one or more channels of the set of channels based at least in part on the second beam indication type being a same beam indication type as the first beam indication type.

In some aspects, the UE includes means for applying the second beam indication to the one or more channels of the set of channels based at least in part on the second beam indication type being compatible with the first beam indication type.

In some aspects, the UE includes means for receiving a first indication of one or more beam indication types that are enabled for the set of channels, means for receiving a second indication of compatibility of different beam indication types, of the set of one or more beam indication types, for the first channel, and/or means for receiving the first indication and the second indication.

In some aspects, the UE includes means for applying the second beam indication to the first channel and not to the second channel.

In some aspects, the UE includes means for applying the second beam indication to the first channel and to the second channel.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

Some networks may use different beam indication types for indicating one or more beams to use for communication via a set of channels. In some aspects, types of beam indication types may include a beam indication that indicates to use a common beam for multiple channels and/or resources for reference signals, and/or beam indication types that include a single beam indication that indicates to use a beam for a single channel or a resource for reference signals.

A beam indication type 1 may indicate a joint uplink/downlink transmission configuration information (TCI) state to indicate a common beam for at least one downlink channel and/or resource for downlink reference signals and for at least one uplink channel or resource for uplink reference signals. A beam indication type 2 may indicate a separate downlink common TCI state to indicate a common beam for at least two downlink channels or resources for downlink reference signals. A beam indication type 3 may indicate a separate uplink common TCI state to indicate a common beam for at least two uplink channels or resources for uplink reference signals.

A beam indication type 4 may indicate a single TCI state to indicate a single beam for a single downlink channel or resource for downlink reference signals. A beam indication type 5 may indicate a single TCI state to indicate a single beam for a single uplink channel or resource for uplink reference signals. A beam indication type 6 may indicate a single uplink spatial relation to indicate a single beam for a single uplink channel or resource for uplink reference signals.

In some networks, the UE may receive a first beam indication, having a first beam indication type, for a first channel or resource and may subsequently receive a second beam indication, having a second beam indication type, for the first channel or resource. The UE may determine a conflict between the first beam indication type and the second beam indication type. For example, the first beam indication type may be the beam indication type 1 that indicates a first beam for a downlink channel and for an uplink channel. The second beam indication type may be the beam indication type 4 that indicates a second beam for the downlink channel. The UE may become out of sync regarding a beam to use for the uplink channel based at least in part on a most recent beam indication (e.g. the beam indication type 4) updating a beam for only one channel associated with the beam in a prior beam indication (e.g., the beam indication type 1). Based at least in part on the UE and the base station becoming out of sync, the UE and the base station may consume processing, power, communication, and/or network resources to detect being out of sync and to reestablish synchronization between the UE and the base station.

In some aspects described herein, a base station may transmit a set of beam indications, associated with a set of beam indication types, for a set of beams that a UE is to use for communication via a set of channels. The set of beam indications includes a first beam indication, associated with a first beam indication type, that indicates to use a first beam for communication via at least a first channel of the set of channels.

The base station may determine to update the first beam for communication via the first channel. The base station may select a second beam indication type for transmission of a second beam indication that indicates to use a second beam for communication via at least the first channel. In some aspects, the base station may provide configuration information to configure the UE with how to interpret the second beam indication type after receiving the first beam indication for a same channel.

In some aspects, the base station may select the second beam indication type based at least in part on the second beam indication type being compatible with the first beam indication type. In some aspects, the base station may select the second beam indication type to update the first beam for communication via the first channel, based at least in part on a configuration at the UE to interpret the second beam indication type to update the first beam to a second beam for only the first channel or to interpret the second beam indication type to update the first beam to the second beam for the first channel and any other beams indicated in the first beam indication, depending on a desired outcome (e.g., to update only the first beam to the second beam for only the first channel or to update all channels indicated in the first beam indication to the second beam).

In some aspects, the base station may enable or disable different beam indication types for a UE and/or for a channel (e.g., based at least in part on a previous beam indication type associated with the channel), among other examples. In some aspects, the base station may be configured to disallow different beam indication types (e.g., from different sets of beam indication types), may allow different beam indication types without restriction, or may allow different beam indication types with restrictions to resolve a beam indication conflict from different beam indication types for a same channel and/or reference signal resource.

Based at least in part on the base station selecting a second beam indication type to use to update a beam based at least in part on a first beam indication type used previously to indicate a beam for a first channel, the base station may select the second beam indication type based at least in part on a known configuration of the UE for interpreting the second beam indication type. In this way, the base station and the UE may maintain synchronization regarding a beam to use for communicating via a second channel. Based at least in part on maintaining synchronization regarding the beam to use for communicating via the second channel, the UE and/or the base station may conserve processing, power, communication, and/or network resources that may have otherwise been used to detect being out of sync and to reestablish synchronization between the UE and the base station.

FIG. 3 is a diagram illustrating an example 300 of beam indications associated with various beam indication types, in accordance with of the present disclosure. As shown in FIG. 3, a UE (e.g., UE 120) may communicate with a base station (e.g., base station 110). In some aspects, the UE and the base station may be part of a wireless network (e.g., wireless network 100).

As shown by reference number 305, the UE may receive configuration information (e.g., from the base station, another base station, and/or the like) and/or may determine the configuration information based at least in part on a communication protocol. In some aspects, the UE may receive the configuration information via one or more of radio resource control (RRC) signaling, medium access control control elements (MAC CEs), and/or the like. In some aspects, the configuration information may include an indication of one or more configuration parameters (e.g., already known to the UE) for selection by the UE, explicit configuration information for the UE to use to configure the UE, and/or the like.

In some aspects, the configuration information may indicate how the UE is to interpret a second beam indication, of a second beam indication type, that indicates a second beam to use for a channel, when a first beam was previously indicated for use with the channel via a first beam indication of a first beam indication type. For example, the configuration information may indicate that the UE is to use the second beam for communications for all channels indicated to use the first beam by the first beam indication. Alternatively, the configuration information may indicate that the UE is to use the second beam for communications for only the first channel and not for a second channel indicated to use the first beam by the first beam indication.

In some aspects, the configuration information may indicate one or more beam indication types that are compatible with each other. For example, the configuration information may indicate that the beam indication type 1 is compatible with the beam indication type 2 and the beam indication type 3. In some aspects, the configuration information may indicate one or more beam indication types that are incompatible with each other. For example, the configuration information may indicate that the fifth beam indication type is incompatible with the sixth beam indication type.

In some aspects, the configuration information may disable or enable one or more beam indication types for a UE, for a set of UEs, for a channel, and/or for a set of channels, among other examples. Based at least in part on the configuration information, the UE may not expect to receive a disabled beam indication type. In other words, the UE may not attempt to receive a disabled beam indication type and/or may discard a disabled beam indication type if received.

As shown by reference number 310, the UE may configure the UE for communicating with the base station. In some aspects, the UE may configure the UE based at least in part on the configuration information. In some aspects, the UE may be configured to perform one or more operations described herein.

As shown by reference number 315, the UE may receive, and the base station may transmit, a set of beam indications. For example, the base station may transmit a set of (e.g., one or more) beam indications for a set of beams to use for communication via a set of channels. The set of beam indications may be associated with a set of beam indication types (e.g., a same beam indication type or different beam indication types). In some aspects, the set of beam indication types may include a first beam indication type for a first channel and a second beam indication type for a second channel, where the first beam indication type and the second beam indication type are incompatible for a same channel. In other words, the second beam indication type may be incompatible for use with the first beam indication type on a same channel (e.g., on a channel associated with a first beam indication) and may be permitted for use on a different channel.

In some aspects, the set of beam indications may include a first beam indication that indicates to use a first beam for communication via at least a first channel of the set of channels. In some aspects, the first beam indication may indicate to use the first beam for the first channel and for a second channel. The first beam indication may be associated with a first beam indication type of the set of beam indication types.

In some aspects, the set of channels associated with the set of beams may include an uplink data channel, a downlink data channel, an uplink control channel, a downlink control channel, a channel associated with transmission or reception of reference signals, and/or one or more resources for transmission or reception of control information or reference signals, among other examples.

As shown by reference number 320, the base station may disable one or more beam indication types based at least in part on the set of beam indications. In some aspects, the base station may disable a set of beam indication types based at least in part on a likelihood of using the set of beam indication types resulting in becoming out of sync with the UE for communications via one or more channels.

As shown by reference number 325, the UE may receive, and the base station may transmit, an indication of one or more beam indication types that are enabled and/or an indication of compatibility of beam indication types. For example, the base station may transmit an indication of one or more beam indication types that are enabled for subsequent beam indications associated with one more of the set of channels. Based at least in part on the UE receiving the indication of the one or more beam indication types that are enabled and/or the indication of compatibility of beam indication types, the UE may not expect to receive (e.g., may not attempt to receive and/or may discard) one or more beam indication types that are disabled or that are incompatible with a previously received beam indication type for the UE and/or for an associated channel.

In some aspects, the base station may transmit one or both of the indications via RRC signaling, MAC CE signaling, and/or downlink control information (DCI) signaling. In some aspects, the base station may transmit one or both of the indications via the configuration information described with respect to reference number 305. In some aspects, the base station may transmit one or both of the indications via a resource grant or an RRC configuration operation, among other examples.

In some aspects, one or both of the indications may include an implied indication. For example, one or both of the indications may be implied via configuration information associated with the one or more beam indication types, beam indication type indicators associated with candidate beam indications, and/or operation parameters, associated with an uplink transmission or a downlink transmission, signaled with the set of one or more beam indications, among other examples.

As shown by reference number 330, the base station may select a second beam indication type for transmission of a second beam indication type. For example, the base station may select the second beam indication type for transmission of a second beam indication that indicates to use a second beam for communication via at least the first channel of the set of channels. The base station may select the second beam indication type based at least in part on the set of one or more beam indication types (e.g., the first beam indication type associated with the first channel). In some aspects, the base station may determine to transmit an updated beam for one or more channels based at least in part on channel conditions, network loading, and/or a conditions of the UE, among other examples.

In some aspects, the base station may select the second beam indication type based at least in part on priorities of the first beam indication type and the second beam indication type. For example, the base station may select the second beam indication type based at least in part on the second beam indication type being associated with a higher priority than a priority associated with the first beam indication type.

Based at least in part on the base station transmitting the set of beam indications, and/or based at least in part on one or more beam indication types being disabled, incompatible, or configured to produce an undesired result (e.g., unwanted beam updating for other channels), the base station may select the second beam indication type based at least in part on a previously transmitted beam indication for the first channel.

In some aspects, the base station may select the second beam indication type based at least in part on the second beam indication type being a same beam indication type as the first beam indication type. In some aspects, the first beam indication type is a different beam indication type than the second beam indication type, and the base station may select the second beam indication type based at least in part on the second beam indication type being compatible with the first beam indication type.

In some aspects, the second beam indication type may be compatible with the first beam indication type based at least in part on the first beam indication type and the second beam indication type being configured within a set of compatible beam indication types. In some aspects, the second beam indication type may be compatible with the first beam indication type based at least in part on the first beam indication type and the second beam indication type each being configured to indicate a common beam for a set of at least two channels. In some aspects, the second beam indication type may be compatible with the first beam indication type based at least in part on the first beam indication type and the second beam indication type each being configured to indicate a single beam for a single channel. In some aspects, the second beam indication type may be compatible with the first beam indication type based at least in part on the first beam indication type and the second beam indication type each being configured to indicate a single beam for at least two uplink channels or at least two downlink channels. In some aspects, the second beam indication type may be compatible with the first beam indication type based at least in part on the first beam indication type and the second beam indication type each being configured to indicate a single beam for at least one uplink channel and at least one downlink channel. In some aspects, the second beam indication type may be compatible with the first beam indication type based at least in part on the first beam indication type and the second beam indication type each being configured to indicate a transmission configuration information state for an uplink channel. In some aspects, the second beam indication type may be compatible with the first beam indication type based at least in part on the first beam indication type and the second beam indication type each being configured to indicate a spatial relation for an uplink channel.

In some aspects, the second beam indication type may be incompatible with the first beam indication type based at least in part on the first beam indication type and the second beam indication type being configured within a set of incompatible beam indication types or not being configured within a set of compatible beam indication types. In some aspects, the second beam indication type may be incompatible with the first beam indication type based at least in part on the first beam indication type and the second beam indication type each being configured to indicate different beams for a set of at least two channels. In some aspects, the second beam indication type may be incompatible with the first beam indication type based at least in part on the first beam indication type and the second beam indication type each being configured to indicate different beams for a single channel. In some aspects, the second beam indication type may be incompatible with the first beam indication type based at least in part on the first beam indication type and the second beam indication type each being configured to indicate different beams for at least two uplink channels or at least two downlink channels. In some aspects, the second beam indication type may be incompatible with the first beam indication type based at least in part on the first beam indication type and the second beam indication type each being configured to indicate multiple beams for one uplink channel or one downlink channel. In some aspects, the second beam indication type may be incompatible with the first beam indication type based at least in part on the first beam indication type being configured to indicate a transmission configuration information state for an uplink channel and the second beam indication type each being configured to indicate a spatial relation for the uplink channel.

As shown by reference number 335, the UE may receive, and the base station may transmit, the second beam indication. For example, the base station may transmit the second beam indication using the second beam indication type.

In some aspects, the second beam indication may be configured to indicate to use the second beam for communication via the first channel and not to use the second beam for communication via the second channel. Alternatively, the second beam indication may be configured to indicate to use the second beam for communication via the first channel and for the second beam for communication via the second channel. In some aspects, the second beam indication may be configured to indicate whether or not to use the second beam for communication via the second channel based at least in part on the UE receiving the configuration information (e.g., as described with respect to reference number 305) that indicates how to interpret the second beam indication type for the first channel after receiving the first beam indication type for the first channel.

As shown by reference number 340, the base station and the UE may communicate via the set of channels. For example, the base station and the UE may communicate via the set of channels based at least in part on application of the second beam indication to one or more channels of the set of channels (e.g., to the first channel and/or to the second channel).

In some aspects, the UE and the base station may apply the second beam indication to the one or more channels of the set of channels based at least in part on the second beam indication type being a same beam indication type as the first beam indication type. In some aspects, the UE and the base station may apply the second beam indication to the one or more channels of the set of channels based at least in part on the second beam indication type being compatible with the first beam indication type. In some aspects, the UE and the base station may apply the second beam indication to the one or more channels of the set of channels based at least in part on the second beam indication type being associated with a higher priority than a priority associated with the second beam indication type.

In some aspects, the UE and the base station may apply the second beam indication to the first channel and not to the second channel. In some aspects, the UE and the base station may apply the second beam indication to the first channel and to the second channel.

Based at least in part on the base station selecting a second beam indication type to use to update a beam, with the selection based at least in part on a first beam indication type used previously to indicate a beam for a first channel, the base station may select the second beam indication type based at least in part on a known configuration of the UE for interpreting the second beam indication type. In this way, the base station and the UE may maintain synchronization regarding a beam to use for communicating via a second channel. Based at least in part on maintaining synchronization regarding the beam to use for communicating via the second channel, the UE and/or the base station may conserve processing, power, communication, and/or network resources that may have otherwise been used to detect being out of sync and to reestablish synchronization between the UE and the base station.

As indicated above, FIG. 3 is provided as an example. Other examples may differ from what is described with regard to FIG. 3.

FIG. 4 is a diagram illustrating an example process 400 performed, for example, by a base station, in accordance with of the present disclosure. Example process 400 is an example where the base station (e.g., base station 110) performs operations associated with beam indications associated with various beam indication types.

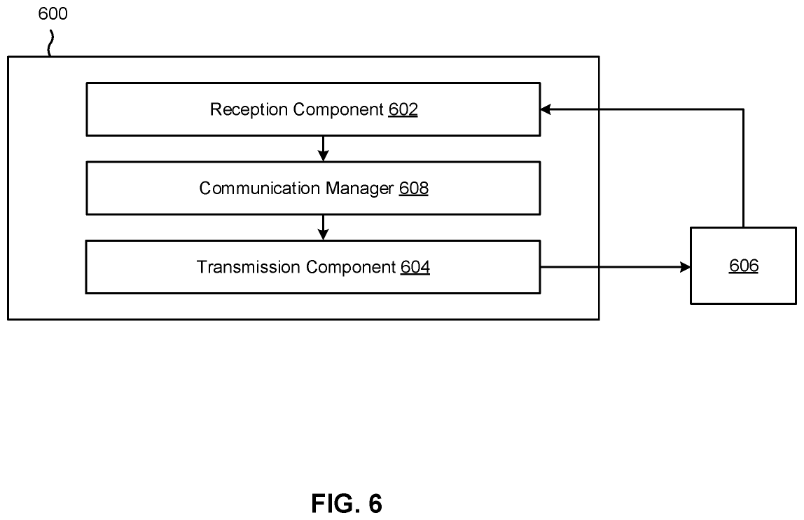

As shown in FIG. 4, in some aspects, process 400 may include transmitting, to a UE, a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels (block 410). For example, the base station (e.g., using transmission component 604, depicted in FIG. 6) may transmit, to a UE, a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels, as described above. In some aspects, the set of one or more beam indications includes a first beam indication, associated with a first beam indication type, that indicates to use a first beam for communication via at least a first channel of the set of channels.

As further shown in FIG. 4, in some aspects, process 400 may include selecting, based at least in part on the set of one or more beam indication types, a second beam indication type for transmission of a second beam indication that indicates to use a second beam for communication via at least the first channel of the set of channels (block 420). For example, the base station (e.g., using communication manager 608, depicted in FIG. 6) may select, based at least in part on the set of one or more beam indication types, a second beam indication type for transmission of a second beam indication that indicates to use a second beam for communication via at least the first channel of the set of channels, as described above.

As further shown in FIG. 4, in some aspects, process 400 may include transmitting the second beam indication using the second beam indication type (block 430). For example, the base station (e.g., using transmission component 604, depicted in FIG. 6) may transmit the second beam indication using the second beam indication type, as described above.

Process 400 may include additional aspects, such as any single aspect or any combination of aspects described below and/or in connection with one or more other processes described elsewhere herein.

In a first aspect, selecting the second beam indication type comprises selecting the second beam indication type based at least in part on the second beam indication type being a same beam indication type as the first beam indication type.

In a second aspect, alone or in combination with the first aspect, the first beam indication type is a different beam indication type than the second beam indication type, and selecting the second beam indication type comprises selecting the second beam indication type based at least in part on the second beam indication type being compatible with the first beam indication type.

In a third aspect, alone or in combination with one or more of the first and second aspects, the second beam indication type is compatible with the first beam indication type based at least in part on one or more of the first beam indication type and the second beam indication type each being configured to indicate a common beam for a set of at least two channels, the first beam indication type and the second beam indication type each being configured to indicate a single beam for a single channel, the first beam indication type and the second beam indication type each being configured to indicate a single beam for at least two uplink channels or at least two downlink channels, the first beam indication type and the second beam indication type each being configured to indicate a single beam for at least one uplink channel and at least one downlink channel, the first beam indication type and the second beam indication type each being configured to indicate a transmission configuration information state for an uplink channel, or the first beam indication type and the second beam indication type each being configured to indicate a spatial relation for an uplink channel.

In a fourth aspect, alone or in combination with one or more of the first through third aspects, process 400 includes disabling one or more beam indication types for the set of channels based at least in part on transmission of the set of one or more beam indications, wherein selecting the second beam indication type comprises selecting the second beam indication type from a set of beam indication types that are not disabled.

In a fifth aspect, alone or in combination with one or more of the first through fourth aspects, the set of one or more beam indication types includes a third beam indication type associated with a second channel, and the first beam indication type and the third beam indication type are incompatible for a same channel.

In a sixth aspect, alone or in combination with one or more of the first through fifth aspects, selecting the second beam indication type comprises selecting the second beam indication type based at least in part on the second beam indication type being associated with a higher priority than a priority associated with the first beam indication type.

In a seventh aspect, alone or in combination with one or more of the first through sixth aspects, the first beam indication also indicates to use the first beam for a second channel, and the second beam indication is configured to indicate to use the second beam for communication via the first channel and not to use the second beam for communication via the second channel.

In an eighth aspect, alone or in combination with one or more of the first through seventh aspects, the first beam indication also indicates to use the first beam for a second channel, and the second beam indication is configured to indicate to use the second beam for communication via the first channel and for communication via the second channel.

In a ninth aspect, alone or in combination with one or more of the first through eighth aspects, process 400 includes transmitting an indication of one or more beam indication types that are enabled for subsequent beam indications, wherein transmitting the indication of the one or more beam indication types that are enabled for subsequent beam indications comprises transmitting the indication via one or more of radio resource control signaling, medium access control signaling, or downlinking control information signaling.

In a tenth aspect, alone or in combination with one or more of the first through ninth aspects, process 400 includes transmitting an indication of one or more beam indication types that are enabled for subsequent beam indications, wherein transmitting the indication of the one or more beam indication types that are enabled for subsequent beam indications comprises transmitting an implied indication via one or more of configuration information associated with the one or more beam indication types, beaming indication type indicators associated with candidate beam indications, or operation parameters, associated with an uplink transmission or a downlink transmission, signaled with the set of one or more beam indications.

In an eleventh aspect, alone or in combination with one or more of the first through tenth aspects, the set of channels comprises one or more of an uplink data channel, a downlink data channel, an uplink control channel, a downlink control channel, a channel associated with transmission or reception of reference signals, or one or more resources for transmission or reception of control information or reference signals.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, by a UE, in accordance with of the present disclosure. Example process 500 is an example where the UE (e.g., UE 120) performs operations associated with beam indications associated with various beam indication types.

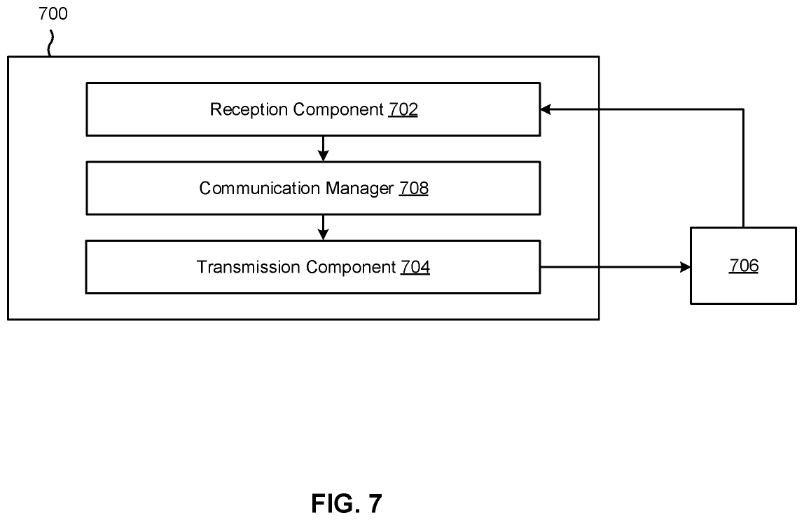

As shown in FIG. 5, in some aspects, process 500 may include receiving a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels (block 510). For example, the UE (e.g., using reception component 702, depicted in FIG. 7) may receive a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels, as described above. In some aspects, the set of one or more beam indications includes a first beam indication, associated with a first beam indication type, that indicates to use a first beam for communication via at least a first channel of the set of channels.

As further shown in FIG. 5, in some aspects, process 500 may include receiving, after reception of the set of one or more beam indications, a second beam indication, associated with a second beam indication type, that indicates to use a second beam for communication via at least the first channel (block 520). For example, the UE (e.g., using reception component 702, depicted in FIG. 7) may receive, after reception of the set of one or more beam indications, a second beam indication, associated with a second beam indication type, that indicates to use a second beam for communication via at least the first channel, as described above.

As further shown in FIG. 5, in some aspects, process 500 may include communicating via the set of channels based at least in part on application of the second beam indication to one or more channels of the set of channels (block 530). For example, the UE (e.g., using reception component 702 and/or transmission component 704, depicted in FIG. 7) may communicate via the set of channels based at least in part on application of the second beam indication to one or more channels of the set of channels, as described above.

Process 500 may include additional aspects, such as any single aspect or any combination of aspects described below and/or in connection with one or more other processes described elsewhere herein.

In a first aspect, communicating via the set of channels based at least in part on application of the second beam indication to the one or more channels of the set of channels comprises applying the second beam indication to the one or more channels of the set of channels based at least in part on the second beam indication type being a same beam indication type as the first beam indication type.

In a second aspect, alone or in combination with the first aspect, communicating via the set of channels based at least in part on application of the second beam indication to the one or more channels of the set of channels comprises applying the second beam indication to the one or more channels of the set of channels based at least in part on the second beam indication type being compatible with the first beam indication type.

In a third aspect, alone or in combination with one or more of the first and second aspects, the second beam indication type is compatible with the first beam indication type based at least in part on one or more of the first beam indication type and the second beam indication type each being configured to indicate a common beam for a set of at least two channels, the first beam indication type and the second beam indication type each being configured to indicate a single beam for a single channel, the first beam indication type and the second beam indication type each being configured to indicate a single beam for at least two uplink channels or at least two downlink channels, the first beam indication type and the second beam indication type each being configured to indicate a single beam for at least one uplink channel and at least one downlink channel, the first beam indication type and the second beam indication type each being configured to indicate a transmission configuration information state for an uplink channel, or the first beam indication type and the second beam indication type each being configured to indicate a spatial relation for an uplink channel.

In a fourth aspect, alone or in combination with one or more of the first through third aspects, communicating via the set of channels based at least in part on application of the second beam indication to the one or more channels of the set of channels is based at least in part on the second beam indication type being associated with a higher priority than a priority associated with the second beam indication type.

In a fifth aspect, alone or in combination with one or more of the first through fourth aspects, process 500 includes receiving a first indication of one or more beam indication types that are enabled for the set of channels, receiving a second indication of compatibility of different beam indication types, of the set of one or more beam indication types, for the first channel, or receiving the first indication and the second indication.

In a sixth aspect, alone or in combination with one or more of the first through fifth aspects, receiving the first indication or receiving the second indication comprises receiving the first indication or the second indication via one or more of radio resource control signaling, medium access control signaling, or downlinking control information signaling.

In a seventh aspect, alone or in combination with one or more of the first through sixth aspects, receiving the first indication or the second indication comprises receiving an implied indication via one or more of: configuration information associated with the one or more beam indication types, beaming indication type indicators associated with candidate beam indications, or operation parameters, associated with an uplink transmission or a downlink transmission, signaled with the set of one or more beam indications.

In an eighth aspect, alone or in combination with one or more of the first through seventh aspects, the first beam indication indicates to use the first beam for communication via a second channel of the set of channels, and communicating via the set of channels based at least in part on application of the second beam indication to the one or more channels of the set of channels comprises applying the second beam indication to the first channel and not to the second channel.

In a ninth aspect, alone or in combination with one or more of the first through eighth aspects, the first beam indication indicates to use the first beam for communication via a second channel of the set of channels, and communicating via the set of channels based at least in part on application of the second beam indication to the one or more channels of the set of channels comprises applying the second beam indication to the first channel and to the second channel.

In a tenth aspect, alone or in combination with one or more of the first through ninth aspects, the set of channels comprises one or more of an uplink data channel, a downlink data channel, an uplink control channel, a downlink control channel, a channel associated with transmission or reception of reference signals, or one or more resources for transmission or reception of control information or reference signals.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a block diagram of an example apparatus 600 for wireless communication. The apparatus 600 may be a base station, or a base station may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include a communication manager 608.

In some aspects, the apparatus 600 may be configured to perform one or more operations described herein in connection with FIG. 3. Additionally, or alternatively, the apparatus 600 may be configured to perform one or more processes described herein, such as process 400 of FIG. 4. In some aspects, the apparatus 600 and/or one or more components shown in FIG. 6 may include one or more components of the base station described above in connection with FIG. 2. Additionally, or alternatively, one or more components shown in FIG. 6 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 606. In some aspects, the reception component 602 may include one or more antennas, a demodulator, a MIMO detector, a receive processor, a controller/processor, a memory, or a combination thereof, of the base station described above in connection with FIG. 2.

The transmission component 604 may transmit communications, such as reference signals, control information, data communications, or a combination thereof, to the apparatus 606. In some aspects, one or more other components of the apparatus 606 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modulator, a transmit MIMO processor, a transmit processor, a controller/processor, a memory, or a combination thereof, of the base station described above in connection with FIG. 2. In some aspects, the transmission component 604 may be co-located with the reception component 602 in a transceiver.

The transmission component 604 may transmit, to a UE, a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels. The communication manager 608 may select, based at least in part on the set of one or more beam indication types, a second beam indication type for transmission of a second beam indication that indicates to use a second beam for communication via at least the first channel of the set of channels. The transmission component 604 may transmit the second beam indication using the second beam indication type.

The communication manager 608 may disable one or more beam indication types for the set of channels based at least in part on transmission of the set of one or more beam indications, wherein selecting the second beam indication type comprises selecting the second beam indication type from a set of beam indication types that are not disabled.

The transmission component 604 may transmit an indication of one or more beam indication types that are enabled for subsequent beam indications, wherein transmitting the indication of the one or more beam indication types that are enabled for subsequent beam indications comprises transmitting the indication via one or more of: radio resource control signaling, medium access control signaling, or downlink control information signaling.

The transmission component 604 may transmit an indication of one or more beam indication types that are enabled for subsequent beam indications, wherein transmitting the indication of the one or more beam indication types that are enabled for subsequent beam indications comprises transmitting an implied indication via one or more of: configuration information associated with the one or more beam indication types, beam indication type indicators associated with candidate beam indications, or operation parameters, associated with an uplink transmission or a downlink transmission, signaled with the set of one or more beam indications.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a block diagram of an example apparatus 700 for wireless communication. The apparatus 700 may be a base station, or a base station may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include communication manager 708.

In some aspects, the apparatus 700 may be configured to perform one or more operations described herein in connection with FIG. 3. Additionally, or alternatively, the apparatus 700 may be configured to perform one or more processes described herein, such as process 500 of FIG. 5. In some aspects, the apparatus 700 and/or one or more components shown in FIG. 7 may include one or more components of the base station described above in connection with FIG. 2. Additionally, or alternatively, one or more components shown in FIG. 7 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the base station described above in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the base station described above in connection with FIG. 2. In some aspects, the transmission component 704 may be co-located with the reception component 702 in a transceiver.

The reception component 702 may receive a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels. The reception component 702 may receive, after reception of the set of one or more beam indications, a second beam indication, associated with a second beam indication type, that indicates to use a second beam for communication via at least the first channel. The reception component 702 and/or the transmission component 704 may communicate via the set of channels based at least in part on application of the second beam indication to one or more channels of the set of channels.

The reception component 702 may receive a first indication of one or more beam indication types that are enabled for the set of channels. The reception component 702 may receive a second indication of compatibility of different beam indication types, of the set of one or more beam indication types, for the first channel. The reception component 702 may receive the first indication and the second indication.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some aspects of the present disclosure:

Aspect 1: A method of wireless communication performed by a base station, comprising: transmitting, to a user equipment (UE), a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels; selecting, based at least in part on the set of one or more beam indication types, a second beam indication type for transmission of a second beam indication that indicates to use a second beam for communication via at least the first channel of the set of channels; and transmitting the second beam indication using the second beam indication type.

Aspect 2: The method of aspect 1, wherein selecting the second beam indication type comprises: selecting the second beam indication type based at least in part on: the second beam indication type being a same beam indication type as the first beam indication type.

Aspect 3: The method of aspect 1, wherein the first beam indication type is a different beam indication type than the second beam indication type, and wherein selecting the second beam indication type comprises selecting the second beam indication type based at least in part on the second beam indication type being compatible with the first beam indication type.

Aspect 4: The method of aspect 3, wherein the second beam indication type is compatible with the first beam indication type based at least in part on one or more of: the first beam indication type and the second beam indication type each being configured to indicate a common beam for a set of at least two channels, the first beam indication type and the second beam indication type each being configured to indicate a single beam for a single channel, the first beam indication type and the second beam indication type each being configured to indicate a single beam for at least two uplink channels or at least two downlink channels, the first beam indication type and the second beam indication type each being configured to indicate a single beam for at least one uplink channel and at least one downlink channel, the first beam indication type and the second beam indication type each being configured to indicate a transmission configuration information state for an uplink channel, or the first beam indication type and the second beam indication type each being configured to indicate a spatial relation for an uplink channel.

Aspect 5: The method of any of aspects 1-4, further comprising: disabling one or more beam indication types for the set of channels based at least in part on transmission of the set of one or more beam indications, wherein selecting the second beam indication type comprises selecting the second beam indication type from a set of beam indication types that are not disabled.

Aspect 6: The method of any of aspects 1-5, wherein the set of one or more beam indication types includes a third beam indication type associated with a second channel, and wherein the first beam indication type and the third beam indication type are incompatible for a same channel.

Aspect 7: The method of any of aspects 1-6, wherein selecting the second beam indication type comprises: selecting the second beam indication type based at least in part on the second beam indication type being associated with a higher priority than a priority associated with the first beam indication type.

Aspect 8: The method of any of aspects 1-7, wherein the first beam indication also indicates to use the first beam for a second channel, and wherein the second beam indication is configured to indicate to use the second beam for communication via the first channel and not to use the second beam for communication via the second channel.

Aspect 9: The method of any of aspects 1-7, wherein the first beam indication also indicates to use the first beam for a second channel, and wherein the second beam indication is configured to indicate to use the second beam for communication via the first channel and for communication via the second channel.

Aspect 10: The method of any of aspects 1-9, further comprising: transmitting an indication of one or more beam indication types that are enabled for subsequent beam indications, wherein transmitting the indication of the one or more beam indication types that are enabled for subsequent beam indications comprises transmitting the indication via one or more of: radio resource control signaling, medium access control signaling, or downlink control information signaling.

Aspect 11: The method of any of aspects 1-10, further comprising: transmitting an indication of one or more beam indication types that are enabled for subsequent beam indications, wherein transmitting the indication of the one or more beam indication types that are enabled for subsequent beam indications comprises transmitting an implied indication via one or more of: configuration information associated with the one or more beam indication types, beam indication type indicators associated with candidate beam indications, or operation parameters, associated with an uplink transmission or a downlink transmission, signaled with the set of one or more beam indications.

Aspect 12: The method of any of aspects 1-11, wherein the set of channels comprises one or more of: an uplink data channel, a downlink data channel, an uplink control channel, a downlink control channel, a channel associated with transmission or reception of reference signals, or one or more resources for transmission or reception of control information or reference signals.

Aspect 13: A method of wireless communication performed by a user equipment (UE), comprising: receiving a set of one or more beam indications, associated with a set of one or more beam indication types, for a set of beams to use for communication via a set of channels, wherein the set of one or more beam indications includes a first beam indication, associated with a first beam indication type, that indicates to use a first beam for communication via at least a first channel of the set of channels; receiving, after reception of the set of one or more beam indications, a second beam indication, associated with a second beam indication type, that indicates to use a second beam for communication via at least the first channel; and communicating via the set of channels based at least in part on application of the second beam indication to one or more channels of the set of channels.

Aspect 14: The method of aspect 13, wherein communicating via the set of channels based at least in part on application of the second beam indication to the one or more channels of the set of channels comprises: applying the second beam indication to the one or more channels of the set of channels based at least in part on the second beam indication type being a same beam indication type as the first beam indication type.

Aspect 15: The method of any of aspects 13 or 14, wherein communicating via the set of channels based at least in part on application of the second beam indication to the one or more channels of the set of channels comprises: applying the second beam indication to the one or more channels of the set of channels based at least in part on the second beam indication type being compatible with the first beam indication type.

Aspect 16: The method of aspect 15, wherein the second beam indication type is compatible with the first beam indication type based at least in part on one or more of: the first beam indication type and the second beam indication type each being configured to indicate a common beam for a set of at least two channels, the first beam indication type and the second beam indication type each being configured to indicate a single beam for a single channel, the first beam indication type and the second beam indication type each being configured to indicate a single beam for at least two uplink channels or at least two downlink channels, the first beam indication type and the second beam indication type each being configured to indicate a single beam for at least one uplink channel and at least one downlink channel, the first beam indication type and the second beam indication type each being configured to indicate a transmission configuration information state for an uplink channel, or the first beam indication type and the second beam indication type each being configured to indicate a spatial relation for an uplink channel.

Aspect 17: The method of any of aspects 13 through 16, wherein communicating via the set of channels based at least in part on application of the second beam indication to the one or more channels of the set of channels is based at least in part on the second beam indication type being associated with a higher priority than a priority associated with the second beam indication type.

Aspect 18: The method of any of aspects 13 through 17, further comprising: receiving a first indication of one or more beam indication types that are enabled for the set of channels, receiving a second indication of compatibility of different beam indication types, of the set of one or more beam indication types, for the first channel, or receiving the first indication and the second indication.

Aspect 19: The method of aspect 18, wherein receiving the first indication or receiving the second indication comprises receiving the first indication or the second indication via one or more of: radio resource control signaling, medium access control signaling, or downlink control information signaling.

Aspect 20: The method of aspect 18, wherein receiving the first indication or the second indication comprises receiving an implied indication via one or more of: configuration information associated with the one or more beam indication types, beam indication type indicators associated with candidate beam indications, or operation parameters, associated with an uplink transmission or a downlink transmission, signaled with the set of one or more beam indications.

Aspect 21: The method of any of aspects 13 through 20, wherein the first beam indication indicates to use the first beam for communication via a second channel of the set of channels, and wherein communicating via the set of channels based at least in part on application of the second beam indication to the one or more channels of the set of channels comprises: applying the second beam indication to the first channel and not to the second channel.

Aspect 22: The method of any of aspects 13 through 20, wherein the first beam indication indicates to use the first beam for communication via a second channel of the set of channels, and wherein communicating via the set of channels based at least in part on application of the second beam indication to the one or more channels of the set of channels comprises: applying the second beam indication to the first channel and to the second channel.

Aspect 23: The method of any of aspects 13 through 22, wherein the set of channels comprises one or more of: an uplink data channel, a downlink data channel, an uplink control channel, a downlink control channel, a channel associated with transmission or reception of reference signals, or one or more resources for transmission or reception of control information or reference signals.

Aspect 24: An apparatus for wireless communication at a device, comprising a processor; memory coupled with the processor; and instructions stored in the memory and executable by the processor to cause the apparatus to perform the method of one or more aspects of aspects 1-23.

Aspect 25: A device for wireless communication, comprising a memory and one or more processors coupled to the memory, the memory and the one or more processors configured to perform the method of one or more aspects of aspects 1-23.

Aspect 26: An apparatus for wireless communication, comprising at least one means for performing the method of one or more aspects of aspects 1-23.

Aspect 27: A non-transitory computer-readable medium storing code for wireless communication, the code comprising instructions executable by a processor to perform the method of one or more aspects of aspects 1-23.

Aspect 28: A non-transitory computer-readable medium storing a set of instructions for wireless communication, the set of instructions comprising one or more instructions that, when executed by one or more processors of a device, cause the device to perform the method of one or more aspects of aspects 1-23.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A base station for wireless communication, comprising:
a memory; and
one or more processors coupled to the memory, the memory and the one or more processors configured to:
transmit, to a user equipment (UE), a set of one or more beam indications, associated with a set of one or more beam indication types, for a set of beams to use for communication via a set of channels,
wherein the set of one or more beam indications includes a first beam indication, associated with a first beam indication type, that indicates to use a first beam for communication via at least a first channel of the set of channels;
select, based at least in part on the set of one or more beam indication types, a second beam indication type for transmission of a second beam indication that indicates to use a second beam for communication via at least the first channel of the set of channels; and
transmit the second beam indication using the second beam indication type.

2. The base station of claim 1, wherein the one or more processors, when selecting the second beam indication type, are configured to:
select the second beam indication type based at least in part on:
the second beam indication type being a same beam indication type as the first beam indication type.

3. The base station of claim 1, wherein the first beam indication type is a different beam indication type than the second beam indication type, and
wherein the one or more processors, when selecting the second beam indication type, are configured to select the second beam indication type based at least in part on the second beam indication type being compatible with the first beam indication type.

4. The base station of claim 3, wherein the second beam indication type is compatible with the first beam indication type based at least in part on one or more of:
the first beam indication type and the second beam indication type each being configured to indicate a common beam for a set of at least two channels,
the first beam indication type and the second beam indication type each being configured to indicate a single beam for a single channel,
the first beam indication type and the second beam indication type each being configured to indicate a single beam for at least two uplink channels or at least two downlink channels,
the first beam indication type and the second beam indication type each being configured to indicate a single beam for at least one uplink channel and at least one downlink channel,
the first beam indication type and the second beam indication type each being configured to indicate a transmission configuration information state for an uplink channel, or
the first beam indication type and the second beam indication type each being configured to indicate a spatial relation for an uplink channel.

5. The base station of claim 1, wherein the one or more processors are further configured to:
disable one or more beam indication types for the set of channels based at least in part on transmission of the set of one or more beam indications,
wherein the one or more processors, when selecting the second beam indication type, are configured to select the second beam indication type from a set of beam indication types that are not disabled.

6. The base station of claim 1, wherein the set of one or more beam indication types includes a third beam indication type associated with a second channel, and
wherein the first beam indication type and the third beam indication type are incompatible for a same channel.

7. The base station of claim 1, wherein the one or more processors, when selecting the second beam indication type, are configured to:
select the second beam indication type based at least in part on the second beam indication type being associated with a higher priority than a priority associated with the first beam indication type.

8. The base station of claim 1, wherein the first beam indication also indicates to use the first beam for a second channel, and
wherein the second beam indication is configured to indicate to use the second beam for communication via the first channel and not to use the second beam for communication via the second channel.

9. The base station of claim 1, wherein the first beam indication also indicates to use the first beam for a second channel, and
wherein the second beam indication is configured to indicate to use the second beam for communication via the first channel and for communication via the second channel.

10. The base station of claim 1, wherein the one or more processors are further configured to:
transmit an indication of one or more beam indication types that are enabled for subsequent beam indications,
wherein the one or more processors, when transmitting the indication of the one or more beam indication types that are enabled for subsequent beam indications, are configured to transmit the indication via one or more of:
radio resource control signaling,
medium access control signaling, or
downlink control information signaling.

11. The base station of claim 1, wherein the one or more processors are further configured to:
transmit an indication of one or more beam indication types that are enabled for subsequent beam indications,
wherein the one or more processors, when transmitting the indication of the one or more beam indication types that are enabled for subsequent beam indications, are configured to transmit an implied indication via one or more of:
configuration information associated with the one or more beam indication types,
beam indication type indicators associated with candidate beam indications, or
operation parameters, associated with an uplink transmission or a downlink transmission, signaled with the set of one or more beam indications.

12. The base station of claim 1, wherein the set of channels comprises one or more of:
an uplink data channel,
a downlink data channel,
an uplink control channel,
a downlink control channel,
a channel associated with transmission or reception of reference signals, or
one or more resources for transmission or reception of control information or reference signals.

13. A user equipment (UE) for wireless communication, comprising:
a memory; and
one or more processors coupled to the memory, the memory and the one or more processors configured to:
receive a set of one or more beam indications, associated with a set of one or more beam indication types, for a set of beams to use for communication via a set of channels,
wherein the set of one or more beam indications includes a first beam indication, associated with a first beam indication type, that indicates to use a first beam for communication via at least a first channel of the set of channels;
receive, after reception of the set of one or more beam indications, a second beam indication, associated with a second beam indication type, that indicates to use a second beam for communication via at least the first channel; and
communicate via the set of channels based at least in part on application of the second beam indication to one or more channels of the set of channels.

14. The UE of claim 13, wherein the one or more processors, when communicating via the set of channels based at least in part on application of the second beam indication to the one or more channels of the set of channels, are configured to:
apply the second beam indication to the one or more channels of the set of channels based at least in part on the second beam indication type being a same beam indication type as the first beam indication type.

15. The UE of claim 13, wherein the one or more processors, when communicating via the set of channels based at least in part on application of the second beam indication to the one or more channels of the set of channels, are configured to:
apply the second beam indication to the one or more channels of the set of channels based at least in part on the second beam indication type being compatible with the first beam indication type.

16. The UE of claim 15, wherein the second beam indication type is compatible with the first beam indication type based at least in part on one or more of:
the first beam indication type and the second beam indication type each being configured to indicate a common beam for a set of at least two channels,
the first beam indication type and the second beam indication type each being configured to indicate a single beam for a single channel,
the first beam indication type and the second beam indication type each being configured to indicate a single beam for at least two uplink channels or at least two downlink channels,
the first beam indication type and the second beam indication type each being configured to indicate a single beam for at least one uplink channel and at least one downlink channel,
the first beam indication type and the second beam indication type each being configured to indicate a transmission configuration information state for an uplink channel, or
the first beam indication type and the second beam indication type each being configured to indicate a spatial relation for an uplink channel.

17. The UE of claim 13, wherein communicating via the set of channels based at least in part on application of the second beam indication to the one or more channels of the set of channels is based at least in part on the second beam indication type being associated with a higher priority than a priority associated with the second beam indication type.

18. The UE of claim 13, wherein the one or more processors are further configured to:
receive a first indication of one or more beam indication types that are enabled for the set of channels,
receive a second indication of compatibility of different beam indication types, of the set of one or more beam indication types, for the first channel, or
receive the first indication and the second indication.

19. The UE of claim 18, wherein the one or more processors, when receiving the first indication or receiving the second indication, are configured to receive the first indication or the second indication via one or more of:
radio resource control signaling,
medium access control signaling, or
downlink control information signaling.

20. The UE of claim 18, wherein the one or more processors, when receiving the first indication or the second indication, are configured to receive an implied indication via one or more of:
configuration information associated with the one or more beam indication types,
beam indication type indicators associated with candidate beam indications, or
operation parameters, associated with an uplink transmission or a downlink transmission, signaled with the set of one or more beam indications.

21. The UE of claim 13, wherein the first beam indication indicates to use the first beam for communication via a second channel of the set of channels, and
wherein the one or more processors, when communicating via the set of channels based at least in part on application of the second beam indication to the one or more channels of the set of channels, are configured to:
apply the second beam indication to the first channel and not to the second channel.

22. The UE of claim 13, wherein the first beam indication indicates to use the first beam for communication via a second channel of the set of channels, and
wherein the one or more processors, when communicating via the set of channels based at least in part on application of the second beam indication to the one or more channels of the set of channels, are configured to:
apply the second beam indication to the first channel and to the second channel.

23. The UE of claim 1313, wherein the set of channels comprises one or more of:
an uplink data channel,
a downlink data channel,
an uplink control channel,
a downlink control channel,
a channel associated with transmission or reception of reference signals, or
one or more resources for transmission or reception of control information or reference signals.

24. A method of wireless communication performed by a base station, comprising:
transmitting, to a user equipment (UE), a set of one or more beam indications, associated with a set of one or more beam indication types, for a set of beams to use for communication via a set of channels,
wherein the set of one or more beam indications includes a first beam indication, associated with a first beam indication type, that indicates to use a first beam for communication via at least a first channel of the set of channels;
selecting, based at least in part on the set of one or more beam indication types, a second beam indication type for transmission of a second beam indication that indicates to use a second beam for communication via at least the first channel of the set of channels; and
transmitting the second beam indication using the second beam indication type.

25. The method of claim 24, wherein selecting the second beam indication type comprises:
selecting the second beam indication type based at least in part on:
the second beam indication type being a same beam indication type as the first beam indication type.

26. The method of claim 24, wherein the first beam indication type is a different beam indication type than the second beam indication type, and
wherein selecting the second beam indication type comprises selecting the second beam indication type based at least in part on the second beam indication type being compatible with the first beam indication type.

27. A method of wireless communication performed by a user equipment (UE), comprising:
receiving a set of one or more beam indications, associated with a set of one or more beam indication types, for a set of beams to use for communication via a set of channels,
wherein the set of one or more beam indications includes a first beam indication, associated with a first beam indication type, that indicates to use a first beam for communication via at least a first channel of the set of channels;
receiving, after reception of the set of one or more beam indications, a second beam indication, associated with a second beam indication type, that indicates to use a second beam for communication via at least the first channel; and
communicating via the set of channels based at least in part on application of the second beam indication to one or more channels of the set of channels.

28. The method of claim 27, wherein communicating via the set of channels based at least in part on application of the second beam indication to the one or more channels of the set of channels comprises:
applying the second beam indication to the one or more channels of the set of channels based at least in part on the second beam indication type being a same beam indication type as the first beam indication type.

29. The method of claim 27, wherein communicating via the set of channels based at least in part on application of the second beam indication to the one or more channels of the set of channels comprises:
applying the second beam indication to the one or more channels of the set of channels based at least in part on the second beam indication type being compatible with the first beam indication type.

30. The method of claim 29, wherein the second beam indication type is compatible with the first beam indication type based at least in part on one or more of:
the first beam indication type and the second beam indication type each being configured to indicate a common beam for a set of at least two channels,
the first beam indication type and the second beam indication type each being configured to indicate a single beam for a single channel,
the first beam indication type and the second beam indication type each being configured to indicate a single beam for at least two uplink channels or at least two downlink channels,
the first beam indication type and the second beam indication type each being configured to indicate a single beam for at least one uplink channel and at least one downlink channel,
the first beam indication type and the second beam indication type each being configured to indicate a transmission configuration information state for an uplink channel, or
the first beam indication type and the second beam indication type each being configured to indicate a spatial relation for an uplink channel.
